(19) United States
(12) Patent Application Publication
(10) Pub. No.: US 2016/0159268 A1
(43) Pub. Date: Jun. 9, 2016

(54) RESILIENT STRAP MEMBER WITH VARIABLE RESISTANCE

(71) Applicant: FGILL ENTERPRISES, L.L.C., Sandy, UT (US)

(72) Inventors: Christopher A. Davies, Sandy, UT (US); Richard B. Davies, Sandy, UT (US)

(21) Appl. No.: 15/019,762

(22) Filed: Feb. 9, 2016

Related U.S. Application Data
(63) Continuation-in-part of application No. 14/167,442, filed on Jan. 29, 2014.
Application No. 14/167,442 is a continuation-in-part of application No. 14/713,630, filed on May 15, 2015.

(51) Int. Cl. B60P 7/08

(52) U.S. Cl. CPC B60P 7/0823; B60P 7/083

(57) ABSTRACT

A restraint assembly includes at least one strap, and a resilient member having two ends, one of which is coupled to the strap such that the resilient member is in line with the strap and provides a resilient link within the restraint assembly. The resilient member has a material discontinuity formed therein, the material discontinuity resulting in the resilient member displaying at least two load response profiles as the two ends of the resilient member are pulled away from one another.

### PRIORITY CLAIM

This is a continuation-in-part of U.S. patent application Ser. No. 14/167,442, filed Jan. 29, 2014, and of U.S. patent application Ser. No. 14/713,630, filed May 15, 2015, the disclosures of which are hereby incorporated herein by reference in their entirety.

### BACKGROUND

1. Field of the Invention

The present invention relates generally to systems for safely and securely shipping and transporting loads. More particularly, the present invention relates to “tie down” or restraint straps for securing a load for storage or transportation.

2. Related Art

Numerous items are loaded and shipped each day in setting such as consumer travel, trucking lines, airline applications, railroads transport and the like. Examples include, without limitation, commercial packages, barrels, crates, vehicles, etc., that are stored on shipping trucks, trains, or aircraft. Additionally, ATVs, motorcycles, camping gear, etc., may be transported on private vehicles on roof racks, truck beds, trailers, etc.

The need for such loads to be well secured is appreciated by anyone with any experience in transporting goods. If any secured item becomes inadvertently dislodged during transport, the results can be catastrophic. Even if the secured item doesn't damage another vehicle, it can itself become damaged if allowed to move.

While a variety of known strap systems have been used to secure such loads, significant problems remain with such systems.

### SUMMARY OF THE INVENTION

It has been recognized that it would be advantageous to develop a securing or strapping assembly that can be easily adapted for use in varying load tensioning conditions.

In accordance with one embodiment, a restraint assembly is provided, including at least one strap and a resilient member having two ends, one of which is coupled to the strap such that the resilient member is in line with the strap and provides a resilient link within the restraint assembly. The resilient member can have a material discontinuity formed therein. The material discontinuity can result in the resilient member displaying at least two load response profiles as the two ends of the resilient member are extended away from one another.

Various other embodiments are also provided, including various methods of making a restraint assembly, of using a restraint assembly and of restraining loads with restraint assemblies.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a perspective view of a strap assembly in accordance with an embodiment of the present invention;

FIG. 2 is a perspective, exploded view of the strap assembly of FIG. 1;

FIG. 3 is a perspective view of another strap assembly in accordance with an embodiment of the present invention;

FIG. 4 is a perspective view of another strap assembly in accordance with an embodiment of the present invention;

FIG. 5 is a perspective view of the strap assembly of FIG. 1, shown in an extended or taught condition;

FIG. 6 is a side view of the strap assembly of FIG. 1, shown securing a load to an arbitrary surface;

FIG. 7 is a side view of the resilient member of FIGS. 1-6;

FIG. 8A is a side view of another resilient member in accordance with an embodiment of the invention, shown in a relaxed condition;

FIG. 8B is a side view of the resilient member of FIG. 8A, shown in a stretched configuration;

FIG. 9A is a schematic side view of a configuration of another resilient member, shown in a relaxed configuration;

FIG. 9B is a schematic side view of another resilient member in accordance with an aspect of the invention;

FIG. 9C is a schematic side view of another resilient member in accordance with an aspect of the invention; and

FIG. 10 is a graph illustrating an exemplary load response of a resilient member in accordance with an embodiment of the invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

### Definitions

As used herein, the singular forms “a” and “the” can include plural referents unless the context clearly dictates otherwise. Thus, for example, reference to “a strap” can include one or more of such fasteners.

As used herein, the terms “attached,” “coupled,” fixed,” etc., can be used to describe a condition in which two or more components are coupled to one another in such a manner that they function as intended: that is, the force required to uncouple the components is sufficiently large such that the components will remain attached to one another during the service for which they were designed. Unless indicated to the contrary, such “coupled” components can be separable if sufficient force is applied to the components. In some aspects of the invention, components are elastically fixed or coupled to one another and will remain fixed during the useful life of the product for which they are designed; however, they may be uncoupled from one another using an appropriate level of force (applied in an appropriate manner and location), and will return to an original configuration (e.g., a condition, state, shape, size, etc.), which existed prior to the components being coupled to one another.

As used herein, the term “substantially” refers to the complete or nearly complete extent or degree of an action, characteristic, property, state, structure, item, or result. As an arbitrary example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. As another arbitrary example, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

The terms “in-line,” “in parallel,” “in series,” etc., are used herein to describe the relationship between various components as loads are applied to and/or carried by such components. For example, a load carried by components that are “in-line” or “in series” is applied equally to each of those components (end-to-end). A load carried by components that are “in parallel” is divided between those components. This relationship of force is analogous to the terms as they are used in electrical circuits. Two straps that are coupled end-to-end are in series or in-line with one another. Two straps that are coupled to the same end points, but lie substantially parallel to one another are in parallel, as that term is used herein.

Invention

As is generally illustrated in the figures, and discussed in more detail below, the present technology provides a strap system that can be advantageously used to secure a wide variety of cargo during transportation. The strap system is well suited for use in consumer applications (e.g., pick-up truck beds, trailers, etc.), commercial applications such as trucking, railroad, marine- and air-craft, etc. While basic “tie-down” systems have been used with some success in the past, they suffer from a number of disadvantages. For example, one major problem with currently employed securing systems is that these systems are substantially static, meaning that they implement only fairly rigid straps, ropes, or other cord-like systems which are designed to apply a static tension to hold the load in position.

One problem which arises from these conventional systems is that the straps, while secure initially, can become loosened as the vehicle vibrates or is jarred either through micro-movements caused by the vibration, or by plastic deformation or other slippage which may occur when the load is jarred. Once the strap system becomes loosened, the integrity of the tie-down is significantly comprised due to any number of factors. One factor which compromises the tie-down's integrity arises from the fact that, after the tie-down becomes loosened, the position of the straps may more easily shift relative to the load, which may allow the load to slip out from under the straps.

An additional factor arises when, once the tie-down is loosened, any subsequent shifting or jarring of the cargo allows for the cargo to accelerate for a small distance prior to engagement of the strap and thereby apply a dynamic load to the strap which may result in tie-down failure. The foregoing examples are not intended to recite an exhaustive list of reasons why a loose tie-down may be inadequate, rather, the foregoing examples merely illustrate that it is generally undesirable to have loose tie-downs on a piece of cargo.

The present invention addresses this and other issues by providing a strap assembly having at least one strap and a resilient member or link within the assembly. This resilient member is intended to be stretched, i.e. elastically expanded along the length of the strap assembly. This resilient member or link within the assembly allows the strap assembly to apply a relatively constant tension to the load or cargo, even given a certain amount of slippage or loosening of the strap assembly due to any vibration or jarring of the load.

This is accomplished by providing a certain amount of damping to vibration, with the vibrations being absorbed by the resilient member. Furthermore, there is a certain degree of elasticity which allows for small movements in the event of a sudden force upon, and subsequent shift of, the cargo. In which case, the resilient member is expanded or stretched rather than allowing the strap to become loosened or moved relative to the secured load.

Additionally the resilient member may be further reinforced by a limiter assembly. This limiter may be coupled to the strap assembly on one or more opposing sides of the resilient member. The limiter can be configured so as to be longer than the resilient member in an un-stretched state. By providing a limiter in such a fashion, the limiter remains un-engaged until the resilient member is stretched sufficiently such that its length matches the length of the limiter. After the resilient member is stretched to such a length, the limiter is engaged and thus prevents the resilient member from stretching further and perhaps exceeding its elastic load capacity.

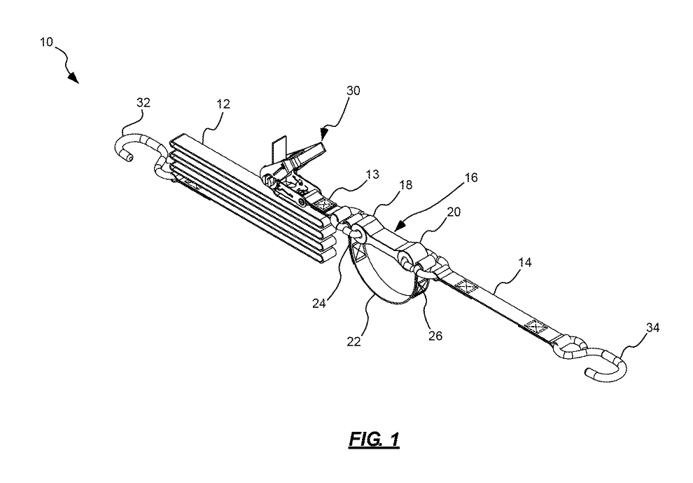

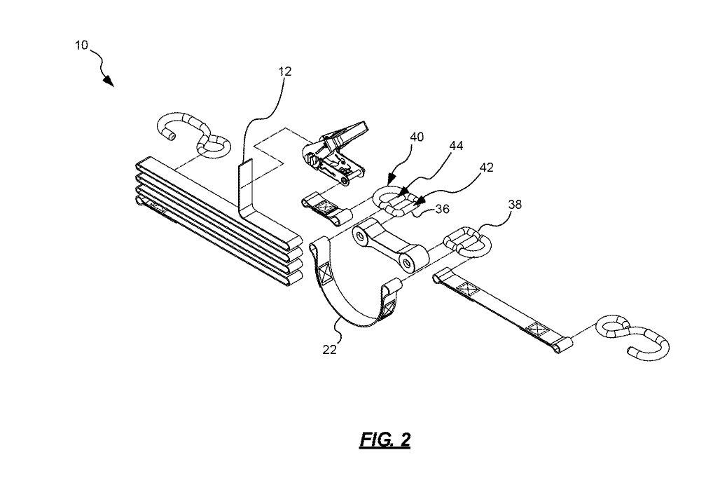

Turning now specifically to the figures, FIGS. 1 and 2 illustrate en exemplary embodiment of the invention which includes a restraint assembly 10. The assembly can include two or more straps 12, 13, 14. A resilient member 16 can include a first end 18 and a second end 20. The resilient member can be coupled to the straps such that the resilient member is in line with the straps and provides a resilient link within the restraint assembly. A limiter 22 can have at least two ends 24, 26. Each of the ends of the limiter can be coupled to the restraint assembly in various locations. The limiter is generally longer than the resilient member 16 when the resilient member is in an un-stretched position. In this manner, the limiter 22 prevents the resilient member 16 from exceeding a maximum predetermined length when the restraint assembly is stretched into a taut condition.

While the various components can be formed from a range of materials, in one aspect, the straps 12, 13, 14 and limiter 22 are formed from nylon webbing, a known material used in such applications as tie-down straps and the like. Such webbing typically will not stretch a great deal from an initial configuration (on the order of about 3%). Thus, the webbing, while stretching slightly when placed into tension, is not designed to extend to any great degree when pulled taught. The resilient member, however, can be formed from thermoplastic elastomer (TPE) or thermoplastic rubber (TPR). This material will typically stretch a great deal, up to about 200% of an initial configuration. The resilient member can thus stretch much more than can the straps and limiter. In one aspect of the invention, the resilient member is capable of elastically stretching about five times or more than will the webbing material.

While not so required, in one aspect of the invention, the resilient member 16 is formed of TPE or TPR. It can include an overall length of about 4⅞ of an inch, a width of about 1⅛ inches, and a thickness (in the center of the member) of about ½ an inch.

In the example shown, a fastener device 30 is provided that can be coupled within the restraint assembly 10. The fastener device is operable to securely engage the strap and retain the strap in a taut condition. As shown, the fastener device is coupled between, and in-line with, straps 12 and 13. In this example, the fastener device comprises a known ratcheting device through which one strap (strap 12 in this case) is threaded. The other end or side of the ratcheting device is coupled to strap 13. The ratcheting device can be used to incrementally and securely tighten the restraint assembly about, around or over a load to be secured.

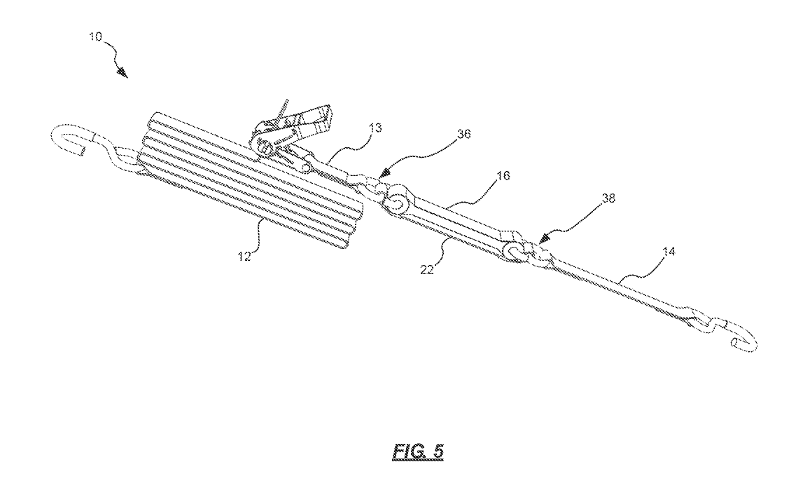

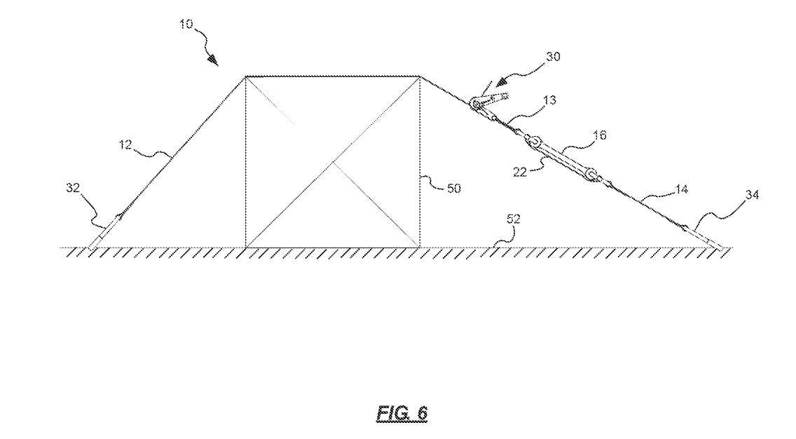

A pair of end fittings 32, 34 can be coupled on opposing ends of the restraint assembly. In the example shown, the end fittings comprise a pair of hooks that can be coupled to auxiliary structure to secure a load (see, e.g., FIG. 6 and the related discussion for more details on this aspect).

FIG. 2 illustrates the restraint assembly 10 in exploded view. In this view, one or more coupling rings 36, 38 can be seen more clearly. The coupling rings can aid in coupling the various components of the system one to another. In one aspect of the invention, the coupling rings can include at least two outer connection points 40, 42 (shown for ring 36 only). One outer connection point 40 can couple the ring to the strap 12 and one outer connection point 42 can couple the ring to the resilient member 16. An inner connection point 44 can be positioned intermediate the outer connection points. The inner connection point can couple the ring 36 to the limiter 22.

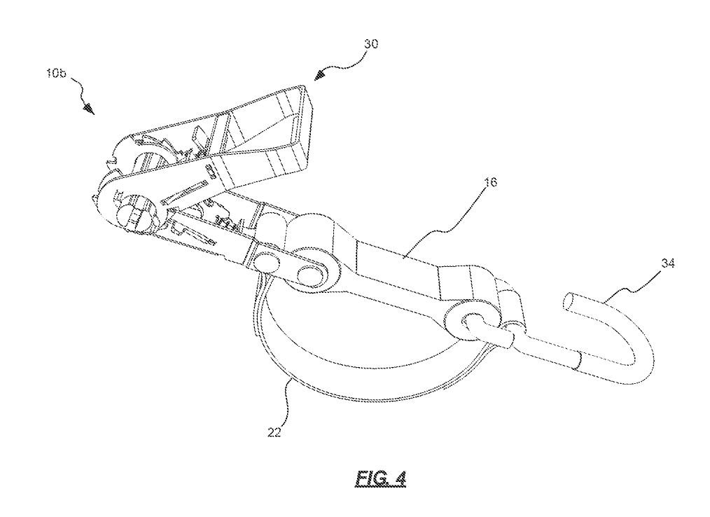

In this manner, the limiter 22 and the resilient member 16 can be configured in a parallel relationship. Thus, as the various strap members are pulled into a taught condition (see, e.g., FIG. 6), the resilient member 16 is also stretched into a taught condition. As also shown in FIG. 5, once the resilient member is stretched to a predetermined maximum length, the limiter 22 is engaged and stretched taught between coupling rings 36 and 38. The limiter then serves to prevent further stretching of the resilient member. Once the restraint assembly 10 is pulled into this configuration, the restraint assembly can maintain a secure restraining force over, around or about a load and will not become loose during transit.

FIG. 3 illustrates an alternate embodiment of the invention in which the fastener device 30a comprises a cam-lock device. In this embodiment, the strap 12 simply pulled through the cam-lock device, and once tensioned is released. At this point, the cam-lock device engages the strap and prevents it from retracting back through the cam-lock.

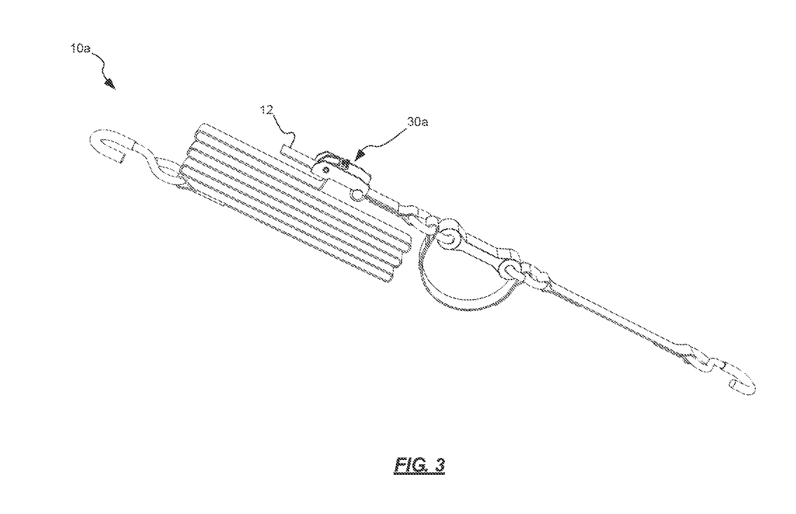

FIG. 4 illustrates an alternate embodiment of the invention in which the resilient member 16 and the limiter 22 are directly coupled between end fitting 34 and ratcheting device 30. This embodiment of the invention can be advantageous in applications where a user wishes to use his or her own strap (not shown) in connection with the current system. This may be the case where a particular application already includes a strap (perhaps already attached to another device) and straps 12, 13, 14 are not desired.

FIG. 5 illustrates the system in use securing a random load 50. The load can, of course, be any number of items such as a crate, a barrel, an ATV, cooler, etc. As shown, end fittings 32, 34 are coupled to some external structure 52 (such as a trailer bed, truck bed, marine vessel, rail car, etc.). Once properly positioned, the ratcheting device 30 can be activated to stretch or pull straps 12, 13, 14 into a taught condition. At this point, the ratchet device can continue to be activated until resilient member 16 is pulled taught and, eventually, until limiter 22 is engaged. The resulting configuration very securely engages the load 50, and is immune to becoming loosened during movement of the external structure 52, even in very severe vibrational and erratic movements.

Turning now to FIGS. 7 through 10, another embodiment of the technology is shown. The resilient member shown at 16 in FIG. 7 is very much like the resilient member discussed above. Resilient member 16a of FIG. 8A, however, includes a material discontinuity formed therein, shown generally by reference 60. The material discontinuity can result in the resilient member displaying at least two load response profiles as the two ends of the resilient member are pulled away from one another. This loading profile is exemplified in FIG. 10, where a generalized loading curve is plotted, with Force represented by the vertical axis, and Extension represented by the horizontal axis.

In the previously discussed embodiments, resilient member 16 will exhibit a relatively linear load response until the limiter (not shown in these figures) is engaged, at which point the load response curve will increase very, very quickly. Resilient member 16a, however, will response with a much lower load response in the initial stages of loading, shown by example at 80 in FIG. 10. This load response will exist more or less continuously until the resilient member is pulled into a linear configuration, as shown by example in FIG. 8B. Once this configuration is achieved, the resilient member 16a will respond similarly to resilient member 16, as shown by example at 82 in FIG. 10. Once the limited is engaged, the load response will increase very rapidly, as shown by example at 84 in FIG. 10.

This aspect of the invention can be advantageous in that loads/cargo can initially be somewhat gently engaged, yet still be retained in place. In the event the load/cargo begins exhibiting severe loading or shifting, the resilient member will extend to the position shown in FIG. 8A, at which point the resilient member will more securely engage the load.

The material discontinuity 60 of resilient member 16a is a bend formed in the (generally) polymeric material of the resilient member. Thus, the resilient member is shown in a relaxed, non-stretched configuration that it will maintain if not loaded. This can be created in the resilient member in a number of manners. In one example, a resilient member shaped similarly to member 16 can be heated/melted and bent into the configuration shown at 16a. Upon cooling, the member will retain the shape shown in FIG. 8A. In another example, the polymeric material of the resilient member 16a can be formed in the shape shown in FIG. 8A, with a suitable mold or other similar process.

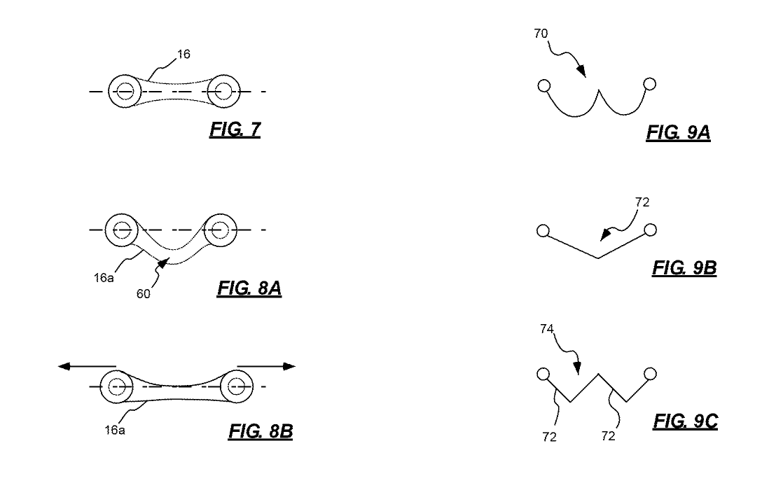

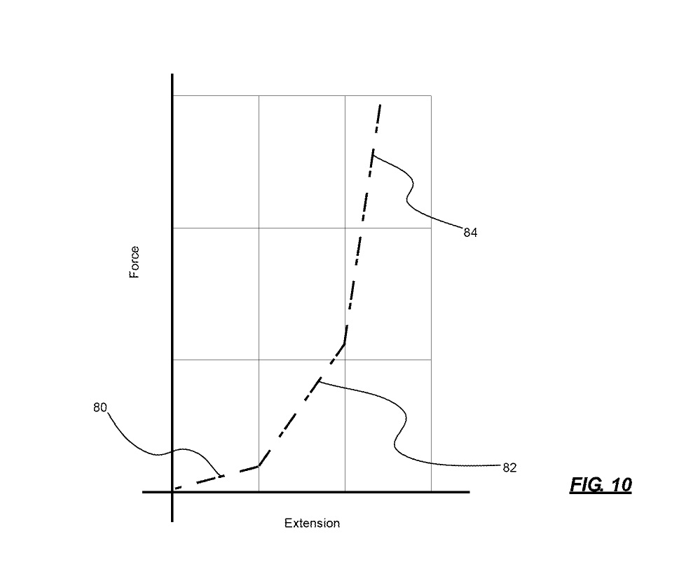

The shape of the member 16a is generally a “U”-shape, with curved transitions between the downwardly extending portion and the upwardly extending portion. In the embodiment shown in FIGS. 8A and 8B, a single “U”-shape unit is provided between opposing ends of the resilient member. FIGS. 9A, 9B and 9C illustrate schematic representations of the shapes of the resilient members that can be provided. Member 70 of FIG. 9A includes two “U”-shaped components arranged side-by-side. FIG. 9B illustrates a more angular, “V”-shaped configuration. FIG. 9C illustrates two “V”-shaped segments. More than two “U” or “V” segments can be arranged together, as can other shapes as well as combinations of various shapes. In addition, while the material discontinuity is shown in the examples when viewing the resilient member from the side, it is to be understood that a similar result can be obtained by modifying a width (into the page of FIG. 7, for example) of the resilient member.

Thus, the technology can include a resilient link comprised of a resilient member formed of elastomeric material such as urethane and generally in the shape of the letter ‘U’ and having two ends, one of which is coupled to a first strap and the other of which is coupled to a second strap. In this manner, when an opposing force is applied to the opposing two straps the ‘U’ shape of the resilient member is first caused to be modified from the ‘U’ shape to a generally straight line shape that is in-line with the applied force. Application of a still greater force causes the resilient member to stretch along its linear axis, in line with the axis of the straps and thereby create a resilient link within the restraint assembly that has a first and second resilient force to resist elongation, where the first force is initially less than the second force.

The resilient link can be formed of elastomeric material such as urethane and generally in the shape of the letter ‘U’ or ‘Z’ or ‘C’ or ‘M’ or other folded shape. The resilient member or link can have two ends such that the unfolding and straightening of the shape requires a linear force applied to the two ends that is less than the subsequent linear force that is required to extend/stretch the resilient member after the area of the shaped portion of the resilient member is extended into a generally linear shape.

Embodiments of the technology allow the creation of a resilient link with a first extension force that is designed to facilitate a low tension to facilitate easy extension to facilitate initial attachment of the resilient link tie down assembly. This can easily be accomplished by human hand while retaining the higher tension extension forces necessary to effectively secure a heavy object by tightening/extending the resilient link with the use of a mechanical ratchet.

The technology also allows the user to directly visualize an indication of the general amount of tension that is being placed on the described resilient link by simply observing the change in shape of the folded resilient link. More specifically, a user can observe how similar the shape of the resilient link is, when under a degree of tension, as compared to the shape of the resilient link when not under tension; as the folded portion of the resilient link will tend to unfold and be pulled into a more in line configuration with increased tension.

In addition to the structural elements discussed above, the present invention also provides methods of securing loads using various straps and resilient members. Methods of forming or modifying a resilient member or link are also provided, as are methods of coupling such links to straps.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A restraint assembly comprising:
at least one strap;
a resilient member having two ends, one of which is coupled to the strap such that the resilient member is in line with the strap and provides a resilient link within the restraint assembly;
the resilient member having a material discontinuity formed therein, the material discontinuity resulting in the resilient member displaying at least two load response profiles as the two ends of the resilient member are pulled away from one another.

2. The restraint assembly of claim 1, further comprising:
a limiter having at least two ends, each of the ends of the limiter being coupled to the restraint assembly, the limiter being longer than the resilient member when the resilient member is in an un-stretched position, such that the limiter prevents the resilient member from exceeding a maximum predetermined length when the restraint assembly is stretched into a taut condition.

3. The assembly of claim 1, further comprising:
a fastener device coupled to the restraint assembly, the fastener device being operable to securely engage the strap and retain the strap in a taut condition.

4. The assembly of claim 3, wherein the fastener device comprises a ratcheting device, the ratcheting device allowing incremental tightening of the strap to provide leveraged tightening of the restraint assembly between two connection points.

5. The assembly of claim 3, wherein the fastener device comprises a cam lock.

6. The assembly of claim 1, wherein the limiter is positioned in parallel with the resilient member when the resilient member is in the taut condition.

7. The assembly of claim 1, wherein the material discontinuity includes a “U”-shaped bend formed in the resilient member when the resilient member is in a relaxed, un-stretched configuration.

8. The assembly of claim 7, wherein the material discontinuity includes a plurality of “U”-shaped bends formed in the resilient member.

9. The assembly of claim 1, wherein the material discontinuity includes a “V” shaped bend formed in the resilient member when the resilient member is in a relaxed, un-stretched configuration.

10. The assembly of claim 9, wherein the material discontinuity includes a plurality of “V”-shaped bends formed in the resilient member.
